(19) United States
(12) Patent Application Publication
(10) Pub. No.: US 2026/0046452 A1
(43) Pub. Date: Feb. 12, 2026

(54) METHOD, APPARATUS, AND MEDIUM FOR POINT CLOUD PROCESSING

(71) Applicants: Douyin Vision Co., Ltd., Beijing (CN); Bytedance Inc., Los Angeles, CA (US)

(72) Inventors: Yichen ZHOU, Beijing (CN); Xiaogi MA, Beijing (CN); Yingzhan XU, Beijing (CN); Kai ZHANG, Los Angeles, CA (US); Li ZHANG, Los Angeles, CA (US); Xinfeng ZHANG, Beijing (CN)

(21) Appl. No.: 19/362,080

(22) Filed: Oct. 17, 2025

Related U.S. Application Data
(63) Continuation of application No. PCT/CN2024/088660, filed on Apr. 18, 2024.

(30) Foreign Application Priority Data
Apr. 19, 2023 (WO) PCT/CN2023/089355

(51) Int. Cl. H04N 19/597; G06N 3/0464; G06N 3/08; H04N 19/105

(52) U.S. Cl. CPC H04N 19/597; G06N 3/0464; G06N 3/08; H04N 19/105

(57) ABSTRACT

Embodiments of the present disclosure provide a solution for point cloud processing. A method for point cloud processing is proposed. The method comprises: obtaining, for a conversion between a current point cloud (PC) sample of a point cloud sequence and a bitstream of the point cloud sequence, a first set of points of the current PC sample, the first set of points representing low frequency information of the current PC sample; obtaining a first feature associated with high frequency information of the current PC sample; and performing the conversion based on the first set of points and the first feature.

### CROSS REFERENCE TO RELATED APPLICATIONS

This application is a continuation of International Application No. PCT/CN2024/088660, filed on Apr. 18, 2024, which claims the benefit of International Application No. PCT/CN2023/089335, filed on Apr. 19, 2023. The entire contents of these applications are hereby incorporated by reference in their entireties.

### FIELDS

Embodiments of the present disclosure relates generally to point cloud processing techniques, and more particularly, to collaborative adaptive downsampling and upsampling of point clouds.

### BACKGROUND

A point cloud is a collection of individual data points in a three-dimensional (3D) plane with each point having a set coordinate on the X, Y, and Z axes. Thus, a point cloud may be used to represent the physical content of the three-dimensional space. Point clouds have shown to be a promising way to represent 3D visual data for a wide range of immersive applications, from augmented reality to autonomous cars.

Point cloud coding standards have evolved primarily through the development of the well-known MPEG organization. MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC or VPCC) is appropriate for point sets with a relatively uniform distribution of points. Geometry-based Point Cloud Compression (G-PCC or GPCC) is appropriate for more sparse distributions. However, coding performance of conventional point cloud coding techniques is generally expected to be further improved.

### SUMMARY

Embodiments of the present disclosure provide a solution for point cloud processing.

In a first aspect, a method for point cloud processing is proposed. The method comprises: obtaining, for a conversion between a current point cloud (PC) sample of a point cloud sequence and a bitstream of the point cloud sequence, a first set of points of the current PC sample, the first set of points representing low frequency information of the current PC sample; obtaining a first feature associated with high frequency information of the current PC sample; and performing the conversion based on the first set of points and the first feature.

Based on the method in accordance with the first aspect of the present disclosure, a point cloud is coded based on a set of points representing low frequency information of the point cloud and a feature associated with high frequency information of the point cloud. Compared with the conventional solution, the proposed method can advantageously utilize collaborative adaptive downsampling and upsampling of a point cloud to assist in coding point cloud. Thereby, the coding performance can be improved.

In a second aspect, an apparatus for point cloud processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a point cloud sequence which is generated by a method performed by an apparatus for point cloud processing. The method comprises: obtaining a first set of points of a current PC sample of the point cloud sequence, the first set of points representing low frequency information of the current PC sample; obtaining a first feature associated with high frequency information of the current PC sample; and generating the bitstream based on the first set of points and the first feature.

In a fifth aspect, a method for storing a bitstream of a point cloud sequence is proposed. The method comprises: obtaining a first set of points of a current PC sample of the point cloud sequence, the first set of points representing low frequency information of the current PC sample; obtaining a first feature associated with high frequency information of the current PC sample; generating the bitstream based on the first set of points and the first feature; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 is a block diagram that illustrates an example point cloud coding system that may utilize the techniques of the present disclosure;

FIG. 2 illustrates a block diagram that illustrates an example point cloud encoder, in accordance with some embodiments of the present disclosure;

FIG. 3 illustrates a block diagram that illustrates an example point cloud decoder, in accordance with some embodiments of the present disclosure;

FIG. 4 illustrates an example flow of the collaborative adaptive downsampling and upsampling method of point clouds in accordance with embodiments of the present disclosure;

FIG. 5 illustrates a flowchart of a method for point cloud processing in accordance with embodiments of the present disclosure; and

FIG. 6 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### EXAMPLE ENVIRONMENT

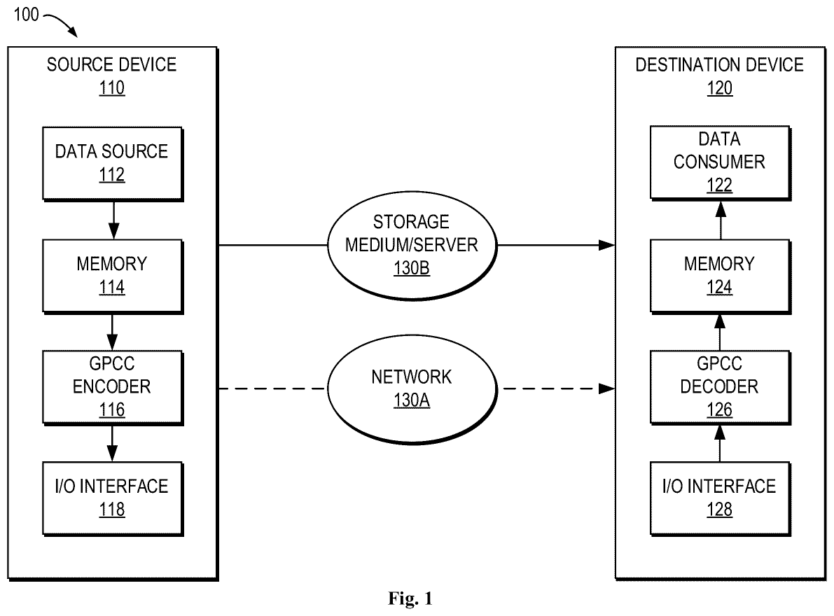

FIG. 1 is a block diagram that illustrates an example point cloud coding system 100 that may utilize the techniques of the present disclosure. As shown, the point cloud coding system 100 may include a source device 110 and a destination device 120. The source device 110 can be also referred to as a point cloud encoding device, and the destination device 120 can be also referred to as a point cloud decoding device. In operation, the source device 110 can be configured to generate encoded point cloud data and the destination device 120 can be configured to decode the encoded point cloud data generated by the source device 110. The techniques of this disclosure are generally directed to coding (encoding and/or decoding) point cloud data, i.e., to support point cloud compression. The coding may be effective in compressing and/or decompressing point cloud data.

Source device 100 and destination device 120 may comprise any of a wide range of devices, including desktop computers, notebook (i.e., laptop) computers, tablet computers, set-top boxes, telephone handsets such as smartphones and mobile phones, televisions, cameras, display devices, digital media players, video gaming consoles, video streaming devices, vehicles (e.g., terrestrial or marine vehicles, spacecraft, aircraft, etc.), robots, LIDAR devices, satellites, extended reality devices, or the like. In some cases, source device 100 and destination device 120 may be equipped for wireless communication.

The source device 100 may include a data source 112, a memory 114, a GPCC encoder 116, and an input/output (I/O) interface 118. The destination device 120 may include an input/output (I/O) interface 128, a GPCC decoder 126, a memory 124, and a data consumer 122. In accordance with this disclosure, GPCC encoder 116 of source device 100 and GPCC decoder 126 of destination device 120 may be configured to apply the techniques of this disclosure related to point cloud coding. Thus, source device 100 represents an example of an encoding device, while destination device 120 represents an example of a decoding device. In other examples, source device 100 and destination device 120 may include other components or arrangements. For example, source device 100 may receive data (e.g., point cloud data) from an internal or external source. Likewise, destination device 120 may interface with an external data consumer, rather than include a data consumer in the same device.

In general, data source 112 represents a source of point cloud data (i.e., raw, unencoded point cloud data) and may provide a sequential series of “frames” of the point cloud data to GPCC encoder 116, which encodes point cloud data for the frames. In some examples, data source 112 generates the point cloud data. Data source 112 of source device 100 may include a point cloud capture device, such as any of a variety of cameras or sensors, e.g., one or more video cameras, an archive containing previously captured point cloud data, a 3D scanner or a light detection and ranging (LIDAR) device, and/or a data feed interface to receive point cloud data from a data content provider. Thus, in some examples, data source 112 may generate the point cloud data based on signals from a LIDAR apparatus. Alternatively or additionally, point cloud data may be computer-generated from scanner, camera, sensor or other data. For example, data source 112 may generate the point cloud data, or produce a combination of live point cloud data, archived point cloud data, and computer-generated point cloud data. In each case, GPCC encoder 116 encodes the captured, pre-captured, or computer-generated point cloud data. GPCC encoder 116 may rearrange frames of the point cloud data from the received order (sometimes referred to as “display order”) into a coding order for coding. GPCC encoder 116 may generate one or more bitstreams including encoded point cloud data. Source device 100 may then output the encoded point cloud data via I/O interface 118 for reception and/or retrieval by, e.g., I/O interface 128 of destination device 120. The encoded point cloud data may be transmitted directly to destination device 120 via the I/O interface 118 through the network 130A. The encoded point cloud data may also be stored onto a storage medium/server 130B for access by destination device 120.

Memory 114 of source device 100 and memory 124 of destination device 120 may represent general purpose memories. In some examples, memory 114 and memory 124 may store raw point cloud data, e.g., raw point cloud data from data source 112 and raw, decoded point cloud data from GPCC decoder 126. Additionally or alternatively, memory 114 and memory 124 may store software instructions executable by, e.g., GPCC encoder 116 and GPCC decoder 126, respectively. Although memory 114 and memory 124 are shown separately from GPCC encoder 116 and GPCC decoder 126 in this example, it should be understood that GPCC encoder 116 and GPCC decoder 126 may also include internal memories for functionally similar or equivalent purposes. Furthermore, memory 114 and memory 124 may store encoded point cloud data, e.g., output from GPCC encoder 116 and input to GPCC decoder 126. In some examples, portions of memory 114 and memory 124 may be allocated as one or more buffers, e.g., to store raw, decoded, and/or encoded point cloud data. For instance, memory 114 and memory 124 may store point cloud data.

I/O interface 118 and I/O interface 128 may represent wireless transmitters/receivers, modems, wired networking components (e.g., Ethernet cards), wireless communication components that operate according to any of a variety of IEEE 802.11 standards, or other physical components. In examples where I/O interface 118 and I/O interface 128 comprise wireless components, I/O interface 118 and I/O interface 128 may be configured to transfer data, such as encoded point cloud data, according to a cellular communication standard, such as 4G, 4G-LTE (Long-Term Evolution), LTE Advanced, 5G, or the like. In some examples where I/O interface 118 comprises a wireless transmitter, I/O interface 118 and I/O interface 128 may be configured to transfer data, such as encoded point cloud data, according to other wireless standards, such as an IEEE 802.11 specification. In some examples, source device 100 and/or destination device 120 may include respective system-on-a-chip (SoC) devices. For example, source device 100 may include an SoC device to perform the functionality attributed to GPCC encoder 116 and/or I/O interface 118, and destination device 120 may include an SoC device to perform the functionality attributed to GPCC decoder 126 and/or I/O interface 128.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

I/O interface 128 of destination device 120 receives an encoded bitstream from source device 110. The encoded bitstream may include signaling information defined by GPCC encoder 116, which is also used by GPCC decoder 126, such as syntax elements having values that represent a point cloud. Data consumer 122 uses the decoded data. For example, data consumer 122 may use the decoded point cloud data to determine the locations of physical objects. In some examples, data consumer 122 may comprise a display to present imagery based on the point cloud data.

GPCC encoder 116 and GPCC decoder 126 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of GPCC encoder 116 and GPCC decoder 126 may be included in one or more encoders or decoders, either of which may be integrated as part of a combined encoder/decoder (CODEC) in a respective device. A device including GPCC encoder 116 and/or GPCC decoder 126 may comprise one or more integrated circuits, microprocessors, and/or other types of devices.

GPCC encoder 116 and GPCC decoder 126 may operate according to a coding standard, such as video point cloud compression (VPCC) standard or a geometry point cloud compression (GPCC) standard. This disclosure may generally refer to coding (e.g., encoding and decoding) of frames to include the process of encoding or decoding data. An encoded bitstream generally includes a series of values for syntax elements representative of coding decisions (e.g., coding modes).

A point cloud may contain a set of points in a 3D space, and may have attributes associated with the point. The attributes may be color information such as R, G, B or Y, Cb, Cr, or reflectance information, or other attributes. Point clouds may be captured by a variety of cameras or sensors such as LIDAR sensors and 3D scanners and may also be computer-generated. Point cloud data are used in a variety of applications including, but not limited to, construction (modeling), graphics (3D models for visualizing and animation), and the automotive industry (LIDAR sensors used to help in navigation).

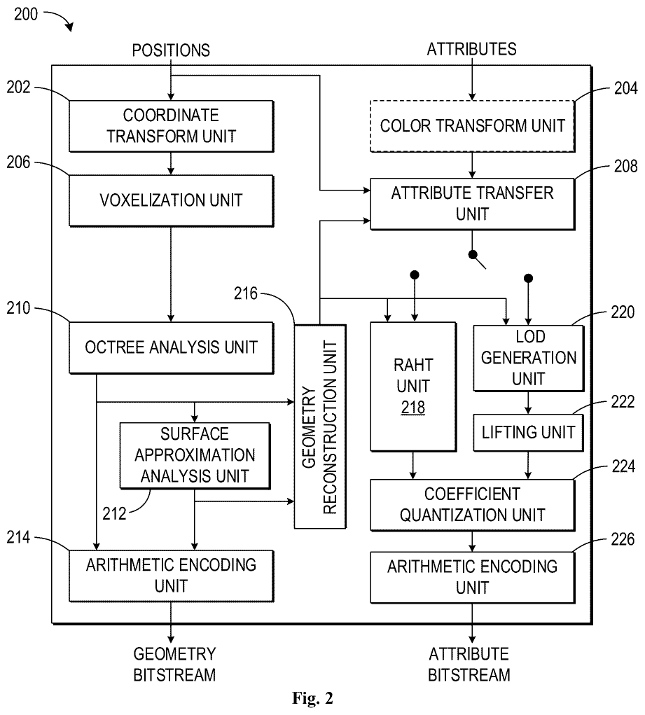

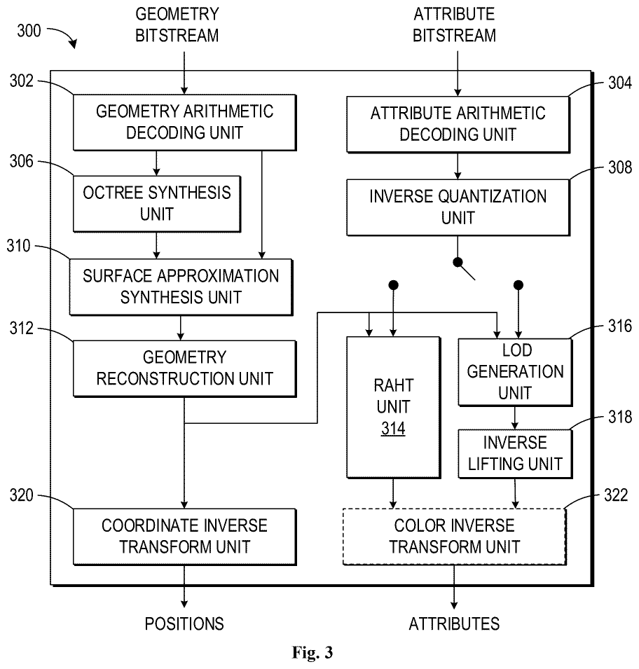

FIG. 2 is a block diagram illustrating an example of a GPCC encoder 200, which may be an example of the GPCC encoder 116 in the system 100 illustrated in FIG. 1, in accordance with some embodiments of the present disclosure. FIG. 3 is a block diagram illustrating an example of a GPCC decoder 300, which may be an example of the GPCC decoder 126 in the system 100 illustrated in FIG. 1, in accordance with some embodiments of the present disclosure.

In both GPCC encoder 200 and GPCC decoder 300, point cloud positions are coded first. Attribute coding depends on the decoded geometry. In FIG. 2 and FIG. 3, the region adaptive hierarchical transform (RAHT) unit 218, surface approximation analysis unit 212, RAHT unit 314 and surface approximation synthesis unit 310 are options typically used for Category 1 data. The level-of-detail (LOD) generation unit 220, lifting unit 222, LOD generation unit 316 and inverse lifting unit 318 are options typically used for Category 3 data. All the other units are common between Categories 1 and 3.

For Category 3 data, the compressed geometry is typically represented as an octree from the root all the way down to a leaf level of individual voxels. For Category 1 data, the compressed geometry is typically represented by a pruned octree (i.e., an octree from the root down to a leaf level of blocks larger than voxels) plus a model that approximates the surface within each leaf of the pruned octree. In this way, both Category 1 and 3 data share the octree coding mechanism, while Category 1 data may in addition approximate the voxels within each leaf with a surface model. The surface model used is a triangulation comprising 1-10 triangles per block, resulting in a triangle soup. The Category 1 geometry codec is therefore known as the Trisoup geometry codec, while the Category 3 geometry codec is known as the Octree geometry codec.

In the example of FIG. 2, GPCC encoder 200 may include a coordinate transform unit 202, a color transform unit 204, a voxelization unit 206, an attribute transfer unit 208, an octree analysis unit 210, a surface approximation analysis unit 212, an arithmetic encoding unit 214, a geometry reconstruction unit 216, an RAHT unit 218, a LOD generation unit 220, a lifting unit 222, a coefficient quantization unit 224, and an arithmetic encoding unit 226.

As shown in the example of FIG. 2, GPCC encoder 200 may receive a set of positions and a set of attributes. The positions may include coordinates of points in a point cloud. The attributes may include information about points in the point cloud, such as colors associated with points in the point cloud.

Coordinate transform unit 202 may apply a transform to the coordinates of the points to transform the coordinates from an initial domain to a transform domain. This disclosure may refer to the transformed coordinates as transform coordinates. Color transform unit 204 may apply a transform to convert color information of the attributes to a different domain. For example, color transform unit 204 may convert color information from an RGB color space to a YCbCr color space.

Furthermore, in the example of FIG. 2, voxelization unit 206 may voxelize the transform coordinates. Voxelization of the transform coordinates may include quantizing and removing some points of the point cloud. In other words, multiple points of the point cloud may be subsumed within a single “voxel,” which may thereafter be treated in some respects as one point. Furthermore, octree analysis unit 210 may generate an octree based on the voxelized transform coordinates. Additionally, in the example of FIG. 2, surface approximation analysis unit 212 may analyze the points to potentially determine a surface representation of sets of the points. Arithmetic encoding unit 214 may perform arithmetic encoding on syntax elements representing the information of the octree and/or surfaces determined by surface approximation analysis unit 212. GPCC encoder 200 may output these syntax elements in a geometry bitstream.

Geometry reconstruction unit 216 may reconstruct transform coordinates of points in the point cloud based on the octree, data indicating the surfaces determined by surface approximation analysis unit 212, and/or other information. The number of transform coordinates reconstructed by geometry reconstruction unit 216 may be different from the original number of points of the point cloud because of voxelization and surface approximation. This disclosure may refer to the resulting points as reconstructed points. Attribute transfer unit 208 may transfer attributes of the original points of the point cloud to reconstructed points of the point cloud data.

Furthermore, RAHT unit 218 may apply RAHT coding to the attributes of the reconstructed points. Alternatively or additionally, LOD generation unit 220 and lifting unit 222 may apply LOD processing and lifting, respectively, to the attributes of the reconstructed points. RAHT unit 218 and lifting unit 222 may generate coefficients based on the attributes. Coefficient quantization unit 224 may quantize the coefficients generated by RAHT unit 218 or lifting unit 222. Arithmetic encoding unit 226 may apply arithmetic coding to syntax elements representing the quantized coefficients. GPCC encoder 200 may output these syntax elements in an attribute bitstream.

In the example of FIG. 3, GPCC decoder 300 may include a geometry arithmetic decoding unit 302, an attribute arithmetic decoding unit 304, an octree synthesis unit 306, an inverse quantization unit 308, a surface approximation synthesis unit 310, a geometry reconstruction unit 312, a RAHT unit 314, a LOD generation unit 316, an inverse lifting unit 318, a coordinate inverse transform unit 320, and a color inverse transform unit 322.

GPCC decoder 300 may obtain a geometry bitstream and an attribute bitstream. Geometry arithmetic decoding unit 302 of decoder 300 may apply arithmetic decoding (e.g., CABAC or other type of arithmetic decoding) to syntax elements in the geometry bitstream. Similarly, attribute arithmetic decoding unit 304 may apply arithmetic decoding to syntax elements in attribute bitstream.

Octree synthesis unit 306 may synthesize an octree based on syntax elements parsed from geometry bitstream. In instances where surface approximation is used in geometry bitstream, surface approximation synthesis unit 310 may determine a surface model based on syntax elements parsed from geometry bitstream and based on the octree.

Furthermore, geometry reconstruction unit 312 may perform a reconstruction to determine coordinates of points in a point cloud. Coordinate inverse transform unit 320 may apply an inverse transform to the reconstructed coordinates to convert the reconstructed coordinates (positions) of the points in the point cloud from a transform domain back into an initial domain.

Additionally, in the example of FIG. 3, inverse quantization unit 308 may inverse quantize attribute values. The attribute values may be based on syntax elements obtained from attribute bitstream (e.g., including syntax elements decoded by attribute arithmetic decoding unit 304).

Depending on how the attribute values are encoded, RAHT unit 314 may perform RAHT coding to determine, based on the inverse quantized attribute values, color values for points of the point cloud. Alternatively, LOD generation unit 316 and inverse lifting unit 318 may determine color values for points of the point cloud using a level of detail-based technique.

Furthermore, in the example of FIG. 3, color inverse transform unit 322 may apply an inverse color transform to the color values. The inverse color transform may be an inverse of a color transform applied by color transform unit 204 of encoder 200. For example, color transform unit 204 may transform color information from an RGB color space to a YCbCr color space. Accordingly, color inverse transform unit 322 may transform color information from the YCbCr color space to the RGB color space.

The various units of FIG. 2 and FIG. 3 are illustrated to assist with understanding the operations performed by encoder 200 and decoder 300. The units may be implemented as fixed-function circuits, programmable circuits, or a combination thereof. Fixed-function circuits refer to circuits that provide particular functionality and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to GPCC or other specific point cloud codecs, the disclosed techniques are applicable to other point cloud coding technologies also. Furthermore, while some embodiments describe point cloud coding steps in detail, it will be understood that corresponding steps decoding that undo the coding will be implemented by a decoder.

### 1. BRIEF SUMMARY

This disclosure is related to point cloud coding pre-processing and post-processing technologies. Specifically, it is related to learning-based point cloud geometry downsampling and upsampling. The ideas may be combined with point cloud coding standard, e.g., the being-developed Geometry based Point Cloud Compression (G-PCC).

### 2. ABBREVIATIONS

G-PCC Geometry based Point Cloud Compression
MPEG Moving Picture Experts Group

### 3. INTRODUCTION

In point cloud compression, traditional octree coding, grid coding, mapping coding, and attribute coding have provided the basic ideas and framework for compression. Following their encoding principles and module structures, people use various signal processing methods to design new modules or optimize and enhance the old ones. The same is true for learning-based point cloud compression, which can replace traditional modules using neural network models and also optimize model parameters based on data-driven optimization.

At present, both the traditional point cloud compression method and the learning-based point cloud compression method try to retain all the information of the original point cloud as much as the code rate allows, but not all the points of the original point cloud are important and deserve to be preserved. Downsampling pre-processing methods can effectively reduce the information redundancy of the original point cloud. The code rate of point cloud can be greatly reduced by down-sampling pre-processing, while the original reconstruction quality can be maintained as much as possible by up-sampling post-processing.

Farthest point sampling (FPS) has been widely used as a pooling operation in point cloud neural processing systems. However, FPS does not take into account the further processing of the sampled points and may result in sub-optimal performance. Recently, alternative sub-sampling methods have been proposed. An existing design introduced a critical points layer, which passes on points with the most active features to the next network layer. An existing design used Gumbel subset sampling during the training of a classification network instead of FPS, to improve its accuracy. For upsampling methods, most of them are based on pointnet base operations. An existing design introduced PU-Net, which learns multi-scale features per point and expands the point set via multi-branch MLPs. However, PU-Net needs to downsample the input first to learn multi-scale features, which causes unnecessary resolution loss., an existing design proposed PU-GAN, a Generative Adverserial Network (GAN) designed to learn upsampled point distributions. While the major contribution and the performance gain is from the discriminator part, the generator architecture receives less attention in their work. All of the current upsampling and downsampling methods are performed separately, there is no joint upsampling and downsampling method, and this method is more suitable for the compression task, which can keep the original reconstruction quality as much as possible while lowering the bit rate.

### 3.1 Sparse Convolution

To exploit the sparsity of point clouds, scholars have conducted many explorations, such as octree-based CNNs and sparse CNNs. For sparse CNNs, the data tensor is represented by a set of coordinates C and the associated features F. The convolution aggregates only the features that are positively occupying the coordinates. It is defined as:

$${f}_{t}^{out} = {\sum }_{i ∈ {N}^{3} ( t , {C}^{i n} )} {W}_{i} {f}_{t + i}^{i n} for t ∈ {C}^{out}$$

where Cⁱⁿ and C^{out} are input coordinates and output coordinates.

$${f}_{t}^{i n} and {f}_{t}^{o u t}$$

are input and output feature vectors at coordinate t. N³(t, Cⁱⁿ)={i|t+i∈Cⁱⁿ, i∈N³}defines a 3D convolutional kernel, covering a set of locations centered at t with offset i's in Cⁱⁿ. Wᵢ denotes the kernel value at offset i. This sparse convolution exploits the sparsity of the point cloud to reduce the complexity and computes only on the positively occupied voxels.

### 4. PROBLEMS

The existing learning-based point cloud downsampling and upsampling methods have the following problems:
1. The current downsampling methods and upsampling methods are split and not well combined to achieve the reconstruction task and used for the post-processing and the pre-processing of the compression.
2. Most of the current down sampling methods are point-based methods, and the low-resolution point clouds obtained in this way are not a subset of the original point clouds with errors. Moreover, these methods are relatively expensive and can only handle small-scale point clouds.
3. Most of the upsampling methods use features to regress the coordinates of the point cloud directly, which makes the upsampling reconstruction difficult and error-prone.
4. The current upsampling and downsampling training mechanism is single, and it is not possible to get a more adapted upsampling network and downsampling network.

### 5. DETAILED SOLUTIONS

To solve the above problems and some other problems not mentioned, methods as summarized below are disclosed. The solutions should be considered as examples to explain the general concepts and should not be interpreted in a narrow way. Furthermore, these solutions can be applied individually or combined in any manner. In the following discussions, the term “encoder” refers to the model to code of the information to be signalled. The term “decoder” refers to the model to decode the compression bits to get the signalled information.
1) It is proposed to down sample the point cloud to obtain low frequency information.
   a. In one example, the low frequency information may be evaluated in terms of the geometric character of point cloud, such as geometric structure or geometric normals.
      i. Furthermore, the low frequency information in the point cloud may be evaluated using the geometric structure.
         1. In one example, the point set (such as uniform point set, farthest sampled point set, etc.) may be used to obtain the backbone structure of the point cloud.
         a. In one example, the farthest sampling method may be used to obtain the farthest sampled point set.
         2. In one example, the voxelized point clouds may be used to characterize the geometric structure of the point cloud.
         a. In one example, sparse point clouds with large granularity voxelization are represented as low-frequency information.
   b. In one example, the low frequency information may be evaluated in terms of the attribute character of point cloud, such as color information.
   c. In one example, the low frequency information may be evaluated in terms of both the geometric character and the attribute character of point cloud.
   d. In one example, the low frequency information may be obtained using a traditional methods or a learning-based approach.
      i. In one example, a neural network-based learning approach may be used to obtain the low frequency information.
         1. In one example, the sparse convolution may be used as the basic operation in the convolutional network.
         a. In one example, the step size of sparse convolution may be N. For example, N is equal to 2.
         b. In one example, N may be pre-defined.
         c. In one example, N may be signalled.
2) It is proposed to down sample the point cloud to obtain high frequency features of the point cloud.
   a. In one example, the high frequency information in the point cloud may be evaluated using the geometric structure.
      i. In one example, the points lost by the downsampling operation may be represented as high-frequency information.
   b. In one example, high-frequency features can be obtained by hand-designed operators or learning-based approach from high frequency information.
      i. In one example, a neural learning approach may be used to obtain the high frequency features.
         1. In one example, the sparse convolution may be used as the basic operation in the convolutional network.
         a. In one example, the features obtained by convolutional downsampling can be considered as high frequency features.
         b. In one example, the step size of sparse convolution may be N. For example, N is equal to 2.
         c. In one example, N may be pre-defined.
         d. In one example, N may be signalled.
3) It is proposed to code and signal the final sampled point cloud to the decoder.
   a. In one example, the final sampled point cloud may be coded by point cloud codec.
      i. In one example, the point cloud codec may be G-PCC, V-PCC, Draco etc.
4) It is proposed to code and signal the features to the decoder.
   a. In one example, the features may be coded with fixed-length coding, unary coding, truncated unary coding, etc. al.
   b. In one example, the features may be coding in a predictive way.
5) It is proposed to predict the high frequency features using initial features.
   a. In one example, the prediction of high frequency features may be using convolution to expand the feature dimension only.
   b. In one example, the prediction of high frequency features may be complex variable-point expansion operations.
   c. In on example, the prediction of high frequency features may be performed using the convolutional block with variable-point feature expansion operations.
      i. In one example, the convolutional block of features prediction may be implemented using sparse convolution.
         1. In one example, multiple consecutive sparse convolution operations may be used. For example, three consecutive sparse convolution operations may be used.
   d. In on example, the predicted high frequency features can be constrained by an effective loss function.
      i. In on example, L2 distance loss function may be used to constrain the difference between the predicted high-frequency features and the true high-frequency features.
      ii. In on example, the cosine similarity loss can be used to constrain the difference between the predicted high-frequency features and the true high-frequency features.
6) It is proposed to get the reconstructed point cloud based on the up-sample result of the decoded point cloud.
   a. In one example, the reconstructed point cloud may be obtained directly by up-sampling in one time.
   b. In one example, the reconstructed point cloud may be obtained directly by multiple progressive up-sampling.
      i. In one example, the point cloud may be reconstructed using N up-sampling operations, such as N=3.
         1. In one example, N may be pre-defined.
         2. In one example, N may be signalled to the decoder.
         a. In one example, N may be coded with fixed-length coding, unary coding, truncated unary coding, etc. al.
         b. In one example, N may be coding in a predictive way.
   c. In one example, the sparse convolution-based generative convolution may be used to achieve point cloud up-sampling.
   d. In one example, multi-stage loss functions with different granularities may be used to constrain neural network during the training process of the up-sampling.
      i. In one example, the binary cross-entropy value may be used as the loss function in the first stage.
      ii. In one example, the numbers of points used in the loss function may be different in different stages.
      iii. In one example, the number of points used in the loss function for each staged may be indicated by at least one indication.
         1. In one example, there are 3 stages and 3 indications, M, N and K.
         a. In one example, M % points of point cloud obtained by voxel sampling from the real point cloud may be used to constrain the reconstructed point cloud in the first stage.
         b. In one example, N % points of point cloud obtained by voxel sampling from the real point cloud may be used to constrain the reconstructed point cloud in the first stage.
         c. In one example, K % points of point cloud obtained by voxel sampling from the real point cloud may be used to constrain the reconstructed point cloud in the last stage.
         d. In one example, M<N<K, such as M=12.5, N=50, K=100.
      iv. In one example, the indication may be pre-defined.
      v. In one example, the indication may be signalled.
7) It is proposed to train the downsampling and upsampling method in different training modes.
   a. In one example, downsampling and upsampling may be trained simultaneously.
   b. In one example, downsampling and upsampling may be trained separately.
   c. In one example, downsampling and upsampling may be trained at the same time, and then up-sampling and down-sampling may be trained separately.
8) Whether to and/or how to apply a method disclosed above may be signaled from encoder to decoder in a bitstream/frame/tile/slice/octree/etc.
9) Whether to and/or how to apply the disclosed methods above may be dependent on coded information, such as dimensions, colour format, colour component, slice/picture type.

### 6. EMBODIMENTS

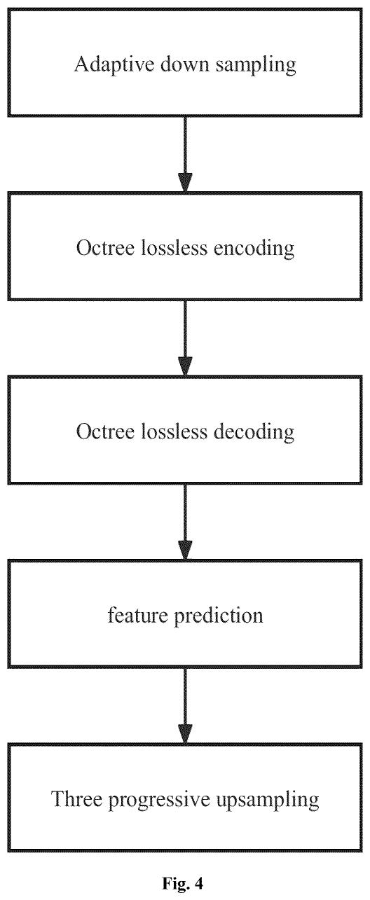

An example of the coding flow for the collaborative adaptive downsampling and upsampling method of point clouds is depicted in FIG. 4. An example of the flow for the collaborative adaptive downsampling and upsampling method of point clouds is as follows. Firstly, the high-resolution original point cloud is passed through a learnable adaptive downsampling network to obtain a low-resolution point cloud that best fits the up-recovery network, which greatly reduces the amount of data in the original point cloud and thus the bit rate. Secondly, the initial features are assigned to the low-resolution point cloud, after the low-resolution point cloud with basic quality is solved from the decoder. Thirdly, the feature prediction module can generate the high frequency information features lost in the downsampling process, which can better guide the point cloud upsampling recovery. Last, the point clouds are reconstructed using progressive upsampling to reduce the reconstruction difficulty, and the reconstruction results are constrained using multi-stage loss function Thus, the multi-stage loss constraint could make the reconstruction better for overall structure.

More details of the embodiments of the present disclosure will be described below which are related to collaborative adaptive downsampling and upsampling of point clouds. The embodiments of the present disclosure should be considered as examples to explain the general concepts and should not be interpreted in a narrow way. Furthermore, these embodiments can be applied individually or combined in any manner.

As used herein, the term “point cloud sequence” may refer to a sequence of one or more point clouds. The term “point cloud frame” or “frame” may refer to a point cloud in a point cloud sequence. The term “point cloud (PC) sample” may refer to a frame, a sub-region within a frame, a picture, a slice, a sub-frame, a sub-picture, a tile, a segment, or any other suitable processing unit.

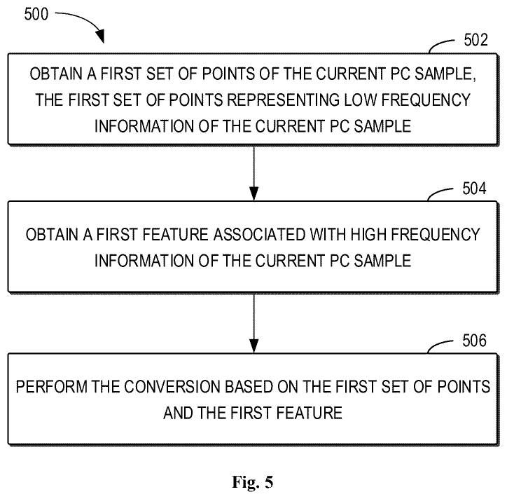

FIG. 5 illustrates a flowchart of a method 500 for point cloud processing in accordance with some embodiments of the present disclosure. The method 500 may be implemented during a conversion between a current PC sample of a point cloud sequence and a bitstream of the point cloud sequence. At 502, a first set of points of the current PC sample is obtained. The first set of points represents low frequency information of the current PC sample. At 504, a first feature associated with high frequency information of the current PC sample is obtained.

In some embodiments, in the encoding process, the first set of points and the first feature may be obtained by downsampling the current PC sample. In the decoding process, the first set of points and the first feature may be decoded from the bitstream. This will be described in detail below.

At 506, the conversion is performed based on the first set of points and the first feature. In some embodiments the conversion may include encoding the current PC sample into the bitstream. Alternatively or additionally, the conversion may include decoding the current PC sample from the bitstream.

In view of the above, a point cloud is coded based on a set of points representing low frequency information of the point cloud and a feature associated with high frequency information of the point cloud. Compared with the conventional solution, the proposed method can advantageously utilize collaborative adaptive downsampling and upsampling of a point cloud to assist in coding point cloud. Thereby, the coding performance can be improved.

The operations which may be performed at the encoding side will be described at first. As briefly mentioned above, the first set of points may be obtained by downsampling the current PC sample. For example, the first set of points is obtained based on geometric character of the current PC sample and/or attribute character of the current PC sample. In other words, the low frequency information may be evaluated in terms of the geometric character and/or the attribute character.

By way of example, the geometric character comprises geometric structure or geometric normal. In one example embodiment, the first set of points may correspond to a backbone structure of the current PC sample. For example, the first set of points may be a uniform point set. Alternatively, the first set of points may be a farthest sampled point set. In this case, the first set of points may be obtained based on a farthest point sampling scheme.

In another example embodiment, the geometric structure may be characterized by a voxelized point cloud. For example, the first set of points may correspond to a sparse point cloud obtained by applying a large granularity voxelization on the current PC sample.

In some further embodiments, the first set of points may be obtained with a first machine learning based (ML-based) model. As used herein, the term “model” is referred to as an association between an input and an output learned from training data, and thus a corresponding output may be generated for a given input after the training. The generation of the model may be based on a machine learning technique. In general, a machine learning model may be built, which receives input information and makes predictions based on the input information. For example, a classification model may predict a class of the input information among a predetermined set of classes. As used herein, “model” may also be referred to as “machine learning model”, “learning model”, “machine learning network”, or “learning network,” which are used interchangeably herein.

In some embodiments, the first ML-based model may comprise a neural network. For example, the neural network may be implemented based on a sparse convolution. In addition, a step size of the sparse convolution may be equal to a first number, such as 2, 3 or the like. In one example, the first number may be predetermined. Alternatively, the first number may be indicated in the bitstream.

In some embodiments, at 504, a second set of points of the current PC sample is obtained. The second set of points represents the high frequency information of the current PC sample. Furthermore, a high frequency feature is generated based on the second set of points, and the first feature is generated based on the high frequency feature.

In some embodiments, the second set of points may be obtained by downsampling the current PC sample. For example, the output of downsampling the current PC sample may comprise both the first set of points representing the low frequency information and the second set of points representing the high frequency information. For example, the second set of points may be determined as points of the current PC sample excluding the first set of points.

In some embodiments, the second set of points may be obtained based on geometric character of the current PC sample. In other words, the high frequency information in the point cloud may be evaluated by using the geometric structure.

In some embodiments, the high frequency feature may be generated with a predetermined operator, which may be hand-designed. Alternatively, the high frequency feature may be generated with a second ML-based model. For example, the second ML-based model may comprise a neural network. The neural network may be implemented based on a sparse convolution. By way of example, a step size of the sparse convolution may be equal to a second number, such as 2, 3 or the like. In one example, the second number may be predetermined. In another example, the second number may be indicated in the bitstream.

In some further embodiments, the high frequency feature may be determined as a feature obtained by convolutional downsampling.

It should be understood the first set of points and the first feature (which may also be referred to as “initial feature” herein) may be determined in any other suitable manner. Moreover, the operations described above may also be implemented at the decoder side. The scope of the present disclosure is not limited in this respect.

Next, the operations which may be performed at the decoding side will be described. As briefly mentioned above, the first set of points and/or the first feature may be obtained from the bitstream.

In some embodiments, at 506, a prediction for a high frequency feature may be generated based on the first feature. Moreover, the current PC sample may be reconstructed by applying a upsampling process on the first set of points based on the prediction for the high frequency feature.

In some embodiments, the prediction for the high frequency feature may be generated with a convolution operation, a complex variable-point expansion operation, a variable-point feature expansion operation, and/or the like. For example, the convolution operation may be implemented with one or more sparse convolutions. In one example, three consecutive sparse convolution operations may be used. It should be understood that the specific values recited herein are intended to be exemplary rather than limiting the scope of the present disclosure.

In some embodiments, the prediction for the high frequency feature may be generated with a third ML-based model. Moreover, parameters of the third ML-based model may be updated based on a loss function during a training process of the third ML-based model. In one example embodiment, the loss function may be determined based on a L2 distance between the predicted high-frequency features and the ground truth high-frequency features. In another example embodiment, the loss function may be determined based on a cosine similarity between the predicted high-frequency features and the ground truth high-frequency features. It should be understood that the possible implementations of the loss function described here are merely illustrative and therefore should not be construed as limiting the present disclosure in any way.

In some embodiments, the upsampling process applied on the first set of points may comprise a single upsampling operation, which corresponds to a one-stage upsampling operation. In some alternative embodiments, the upsampling process may comprise a plurality of upsampling operations that are performed iteratively. For example, the number of the plurality of upsampling operations may be equal to a third number, such as 3, 4 or the like. In one example, the third number may be predetermined. Alternatively, the third number may be comprised in the bitstream. For example, the third number may be coded with a fixed-length coding, a unary coding, or a truncated unary coding. Alternatively, the third number may be coded in a predictive way.

In some embodiments, the upsampling process may be applied by using a sparse convolution-based generative convolution.

In some embodiments, parameters of a fourth ML-based model for applying the upsampling process may be updated based on multi-stage loss functions with different granularities during a training process of the fourth ML-based model. For example, a loss function for the first stage of the multi-stage loss functions may be determined to be a binary cross-entropy value.

In some embodiments, the number of points used for determining loss functions for different stages of the multi-stage loss functions may be different. Moreover, the number of points used for determining a loss function for each stage of the multi-stage loss functions may be indicated by at least one indication. In one example, the at least one indication may be predetermined. Alternatively, the at least one indication may be indicated in the bitstream.

In some embodiments, the multi-stage loss functions may be 3-stage loss functions. For example, a loss function for the first stage of multi-stage loss functions may be determined based on M % points of a point cloud that may be obtained by voxel sampling from a real point cloud for training the fourth ML-based model, a loss function for the second stage of multi-stage loss functions may be determined based on N % points of the point cloud, and a loss function for the last stage of multi-stage loss functions may be determined based on K % points of the point cloud. In one example embodiment, M may be smaller than N, and N may be smaller than K. By way of example, M may be equal to 12.5, N may be equal to 50, and K may be equal to 100.

It should be understood that the operations described above may also be implemented at the encoder side. The scope of the present disclosure is not limited in this respect.

In some embodiments, the above described downsampling process for downsampling the current PC sample to obtain the first set of points and upsampling process for upsampling the first set of points to reconstruct the current PC sample may be performed collaboratively. For example, the downsampling process may be applied to the current PC sample at the encoder side to obtain the first set of points and the first feature. The first set of points and the first feature may be encoded into the bitstream. At the decoder side, the first set of points and the first feature may be decoded from the bitstream. The first feature may be used to predict the high frequency feature, and the current PC sample may be reconstructed based on the high frequency feature and the first set of points.

In some embodiments, a fifth ML-based model for downsampling the current PC sample to obtain the first set of points and a sixth ML-based model for upsampling the first set of points to reconstruct the current PC sample may be trained with different schemes. In one example embodiment, the fifth ML-based model and the sixth ML-based model may be trained simultaneously. In another example, the fifth ML-based model and the sixth ML-based model may be trained separately. In a further example, the fifth ML-based model and the sixth ML-based model may be trained separately after being trained simultaneously.

In some embodiments, the first set of points may be signaled from an encoder to a decoder. For example, the first set of points may be coded by a point cloud codec, such as, G-PCC, V-PCC, Draco, or the like. Additionally or alternatively, the first feature may be signaled from an encoder to a decoder. For example, the first feature may be coded with a fixed-length coding, a unary coding, or a truncated unary coding. Alternatively, the first feature may be coded in a predictive way.

In some embodiments, information regarding whether to and/or how to apply the method may be indicated in the bitstream. In addition, information regarding whether to and/or how to apply the method may be indicated in a frame, a tile, a slice, or an octree, or the like.

In some embodiments, information regarding whether to and/or how to apply the method may be dependent on coded information. By way of example rather than limitation, the coded information may comprise a dimension, a color format, a color component, a slice type, a picture type, or the like.

In view of the above, the solutions in accordance with some embodiments of the present disclosure can advantageously improve coding performance.

According to further embodiments of the present disclosure, a non-transitory computer-readable recording medium is provided. The non-transitory computer-readable recording medium stores a bitstream of a point cloud sequence which is generated by a method performed by an apparatus for point cloud processing. In the method, a first set of points of a current PC sample of the point cloud sequence is obtained. The first set of points represents low frequency information of the current PC sample. Additionally, a first feature associated with high frequency information of the current PC sample is obtained. Furthermore, the bitstream is generated based on the first set of points and the first feature.

According to still further embodiments of the present disclosure, a method for storing bitstream of a point cloud sequence is provided. In the method, a first set of points of a current PC sample of the point cloud sequence is obtained. The first set of points represents low frequency information of the current PC sample. Additionally, a first feature associated with high frequency information of the current PC sample is obtained. Furthermore, the bitstream is generated based on the first set of points and the first feature, and stored in a non-transitory computer-readable recording medium.

Implementations of the present disclosure can be described in view of the following clauses, the features of which can be combined in any reasonable manner.

Clause 1. A method for point cloud processing, comprising: obtaining, for a conversion between a current point cloud (PC) sample of a point cloud sequence and a bitstream of the point cloud sequence, a first set of points of the current PC sample, the first set of points representing low frequency information of the current PC sample; obtaining a first feature associated with high frequency information of the current PC sample; and performing the conversion based on the first set of points and the first feature.

Clause 2. The method of clause 1, wherein the conversion comprises encoding the current PC sample into the bitstream.

Clause 3. The method of any of clauses 1-2, wherein the first set of points is obtained by downsampling the current PC sample.

Clause 4. The method of any of clauses 1-3, wherein the first set of points is obtained based on at least one of the following: geometric character of the current PC sample, or attribute character of the current PC sample.

Clause 5. The method of clause 4, wherein the geometric character comprises geometric structure or geometric normal.

Clause 6. The method of any of clauses 1-5, wherein the first set of points corresponds to a backbone structure of the current PC sample.

Clause 7. The method of any of clauses 1-6, wherein the first set of points is obtained based on a farthest point sampling scheme.

Clause 8. The method of clause 5, wherein the geometric structure is characterized by a voxelized point cloud.

Clause 9. The method of any of clauses 1-5, wherein the first set of points corresponds to a sparse point cloud obtained by applying a large granularity voxelization on the current PC sample.

Clause 10. The method of any of clauses 1-3, wherein the first set of points is obtained with a first machine learning based (ML-based) model.

Clause 11. The method of clause 10, wherein the first ML-based model comprises a neural network.

Clause 12. The method of clause 11, wherein the neural network is implemented based on a sparse convolution.

Clause 13. The method of clause 12, wherein a step size of the sparse convolution is equal to a first number.

Clause 14. The method of clause 13, wherein the first number is predetermined or indicated in the bitstream.

Clause 15. The method of any of clauses 1-14, wherein obtaining the first feature comprises: obtaining a second set of points of the current PC sample, the second set of points representing the high frequency information of the current PC sample; generating a high frequency feature based on the second set of points; and generating the first feature based on the high frequency feature.

Clause 16. The method of clause 15, wherein the second set of points is obtained by downsampling the current PC sample.

Clause 17. The method of any of clauses 15-16, wherein the second set of points is obtained based on geometric character of the current PC sample.

Clause 18. The method of any of clauses 15-17, wherein the second set of points are determined as points of the current PC sample excluding the first set of points.

Clause 19. The method of any of clauses 15-18, wherein the high frequency feature is generated with a predetermined operator or a second ML-based model.

Clause 20. The method of clause 19, wherein the second ML-based model comprises a neural network.

Clause 21. The method of clause 20, wherein the neural network is implemented based on a sparse convolution.

Clause 22. The method of clause 21, wherein a step size of the sparse convolution is equal to a second number.

Clause 23. The method of clause 22, wherein the second number is predetermined or indicated in the bitstream.

Clause 24. The method of any of clauses 15-23, wherein the high frequency feature is determined as a feature obtained by convolutional downsampling.

Clause 25. The method of clause 1, wherein the conversion includes decoding the current PC sample from the bitstream.

Clause 26. The method of clause 1 or 25, wherein the first set of points is obtained from the bitstream, and/or the first feature is obtained from the bitstream.

Clause 27. The method of any of clauses 1 and 25-26, wherein performing the conversion comprises: generating a prediction for a high frequency feature based on the first feature; and reconstructing the current PC sample by applying a upsampling process on the first set of points based on the prediction for the high frequency feature.

Clause 28. The method of clause 27, wherein the prediction for the high frequency feature is generated with at least one of the following: a convolution operation, a complex variable-point expansion operation, or a variable-point feature expansion operation.

Clause 29. The method of clause 28, wherein the convolution operation is implemented with one or more sparse convolutions.

Clause 30. The method of any of clauses 27-29, wherein the prediction for the high frequency feature is generated with a third ML-based model, and parameters of the third ML-based model are updated based on a loss function during a training process of the third ML-based model.

Clause 31. The method of clause 30, wherein the loss function is determined based on a L2 distance or a cosine similarity.

Clause 32. The method of any of clauses 27-31, wherein the upsampling process comprises a single upsampling operation.

Clause 33. The method of any of clauses 27-31, wherein the upsampling process comprises a plurality of upsampling operations that are performed iteratively.

Clause 34. The method of clause 33, wherein the number of the plurality of upsampling operations is equal to a third number.

Clause 35. The method of clause 34, wherein the third number is predetermined, or the third number is comprised in the bitstream.

Clause 36. The method of any of clauses 34-35, wherein the third number is coded with one of the following: a fixed-length coding, a unary coding, or a truncated unary coding.

Clause 37. The method of any of clauses 34-35, wherein the third number is coded in a predictive way.

Clause 38. The method of any of clauses 27-37, wherein the upsampling process is applied by using a sparse convolution-based generative convolution.

Clause 39. The method of any of clauses 27-38, wherein parameters of a fourth ML-based model for applying the upsampling process are updated based on multi-stage loss functions with different granularities during a training process of the fourth ML-based model.

Clause 40. The method of clause 39, wherein a loss function for the first stage of the multi-stage loss functions is determined to be a binary cross-entropy value.

Clause 41. The method of any of clauses 39-40, wherein the number of points used for determining loss functions for different stages of the multi-stage loss functions are different.

Clause 42. The method of any of clauses 39-41, wherein the number of points used for determining a loss function for each stage of the multi-stage loss functions is indicated by at least one indication.

Clause 43. The method of clause 42, wherein the at least one indication is predetermined, or the at least one indication is indicated in the bitstream.

Clause 44. The method of any of clauses 39-43, wherein the multi-stage loss functions are 3-stage loss functions, a loss function for the first stage of multi-stage loss functions is determined based on M % points of a point cloud that is obtained by voxel sampling from a real point cloud for training the fourth ML-based model, a loss function for the second stage of multi-stage loss functions is determined based on N % points of the point cloud, and a loss function for the last stage of multi-stage loss functions is determined based on K % points of the point cloud.

Clause 45. The method of clause 44, wherein M is smaller than N, and N is smaller than K.

Clause 46. The method of any of clauses 1-45, wherein a fifth ML-based model for downsampling the current PC sample to obtain the first set of points and a sixth ML-based model for upsampling the first set of points to reconstruct the current PC sample are trained with different schemes.

Clause 47. The method of any of clauses 1-45, wherein a fifth ML-based model for downsampling the current PC sample to obtain the first set of points and a sixth ML-based model for upsampling the first set of points to reconstruct the current PC sample are trained simultaneously.

Clause 48. The method of any of clauses 1-45, wherein a fifth ML-based model for downsampling the current PC sample to obtain the first set of points and a sixth ML-based model for upsampling the first set of points to reconstruct the current PC sample are trained separately.

Clause 49. The method of any of clauses 1-45, wherein a fifth ML-based model for downsampling the current PC sample to obtain the first set of points and a sixth ML-based model for upsampling the first set of points to reconstruct the current PC sample are trained separately after being trained simultaneously.

Clause 50. The method of any of clauses 1-49, wherein the first set of points is signaled from an encoder to a decoder.

Clause 51. The method of any of clauses 1-50, wherein the first set of points is coded by a point cloud codec.

Clause 52. The method of clause 51, wherein the point cloud codec is one of G-PCC, V-PCC, or Draco.

Clause 53. The method of any of clauses 1-52, wherein the first feature is signaled from an encoder to a decoder.

Clause 54. The method of any of clauses 1-53, wherein the first feature is coded with one of the following: a fixed-length coding, a unary coding, or a truncated unary coding.

Clause 55. The method of any of clauses 1-53, wherein the first feature is coded in a predictive way.

Clause 56. The method of any of clauses 1-55, wherein a PC sample is one of the following: a frame, a picture, a slice, a sub-frame, a sub-picture, a tile, or a segment.

Clause 57. The method of any of clauses 1-56, wherein information regarding whether to and/or how to apply the method is indicated in the bitstream.

Clause 58. The method of any of clauses 1-57, wherein information regarding whether to and/or how to apply the method is indicated in one of the following: a frame, a tile, a slice, or an octree.

Clause 59. The method of any of clauses 1-58, wherein information regarding whether to and/or how to apply the method is dependent on coded information.

Clause 60. The method of clause 59, wherein the coded information comprises at least one of the following: a dimension, a color format, a color component, a slice type, or a picture type.

Clause 61. An apparatus for point cloud processing comprising a processor and a non-transitory memory with instructions thereon, wherein the instructions upon execution by the processor, cause the processor to perform a method in accordance with any of clauses 1-60.

Clause 62. A non-transitory computer-readable storage medium storing instructions that cause a processor to perform a method in accordance with any of clauses 1-60.

Clause 63. A non-transitory computer-readable recording medium storing a bitstream of a point cloud sequence which is generated by a method performed by an apparatus for point cloud processing, wherein the method comprises: obtaining a first set of points of a current PC sample of the point cloud sequence, the first set of points representing low frequency information of the current PC sample; obtaining a first feature associated with high frequency information of the current PC sample; and generating the bitstream based on the first set of points and the first feature.

Clause 64. A method for storing a bitstream of a point cloud sequence, comprising: obtaining a first set of points of a current PC sample of the point cloud sequence, the first set of points representing low frequency information of the current PC sample; obtaining a first feature associated with high frequency information of the current PC sample; generating the bitstream based on the first set of points and the first feature; and storing the bitstream in a non-transitory computer-readable recording medium.

### Example Device

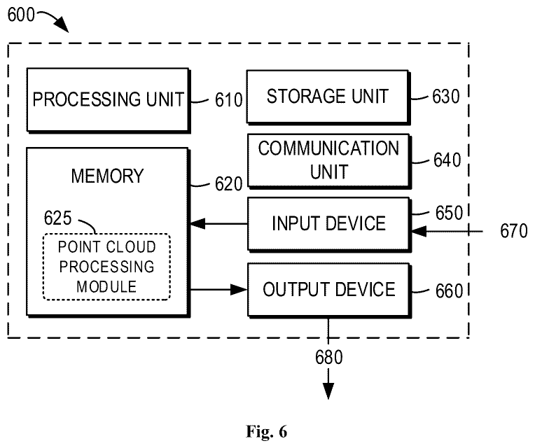

FIG. 6 illustrates a block diagram of a computing device 600 in which various embodiments of the present disclosure can be implemented. The computing device 600 may be implemented as or included in the source device 110 (or the GPCC encoder 116 or 200) or the destination device 120 (or the GPCC decoder 126 or 300).

It would be appreciated that the computing device 600 shown in FIG. 6 is merely for purpose of illustration, without suggesting any limitation to the functions and scopes of the embodiments of the present disclosure in any manner.

As shown in FIG. 6, the computing device 600 includes a general-purpose computing device 600. The computing device 600 may at least comprise one or more processors or processing units 610, a memory 620, a storage unit 630, one or more communication units 640, one or more input devices 650, and one or more output devices 660.

In some embodiments, the computing device 600 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 600 can support any type of interface to a user (such as “wearable” circuitry and the like).

The processing unit 610 may be a physical or virtual processor and can implement various processes based on programs stored in the memory 620. In a multi-processor system, multiple processing units execute computer executable instructions in parallel so as to improve the parallel processing capability of the computing device 600. The processing unit 610 may also be referred to as a central processing unit (CPU), a microprocessor, a controller or a microcontroller.

The computing device 600 typically includes various computer storage medium. Such medium can be any medium accessible by the computing device 600, including, but not limited to, volatile and non-volatile medium, or detachable and non-detachable medium. The memory 620 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 630 may be any detachable or non-detachable medium and may include a machine-readable medium such as a memory, flash memory drive, magnetic disk or another other media, which can be used for storing information and/or data and can be accessed in the computing device 600.

The computing device 600 may further include additional detachable/non-detachable, volatile/non-volatile memory medium. Although not shown in FIG. 6, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 640 communicates with a further computing device via the communication medium. In addition, the functions of the components in the computing device 600 can be implemented by a single computing cluster or multiple computing machines that can communicate via communication connections. Therefore, the computing device 600 can operate in a networked environment using a logical connection with one or more other servers, networked personal computers (PCs) or further general network nodes.

The input device 650 may be one or more of a variety of input devices, such as a mouse, keyboard, tracking ball, voice-input device, and the like. The output device 660 may be one or more of a variety of output devices, such as a display, loudspeaker, printer, and the like. By means of the communication unit 640, the computing device 600 can further communicate with one or more external devices (not shown) such as the storage devices and display device, with one or more devices enabling the user to interact with the computing device 600, or any devices (such as a network card, a modem and the like) enabling the computing device 600 to communicate with one or more other computing devices, if required. Such communication can be performed via input/output (I/O) interfaces (not shown).

In some embodiments, instead of being integrated in a single device, some or all components of the computing device 600 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 600 may be used to implement point cloud encoding/decoding in embodiments of the present disclosure. The memory 620 may include one or more point cloud processing modules 625 having one or more program instructions. These modules are accessible and executable by the processing unit 610 to perform the functionalities of the various embodiments described herein.

In the example embodiments of performing point cloud encoding, the input device 650 may receive point cloud data as an input 670 to be encoded. The point cloud data may be processed, for example, by the point cloud processing module 625, to generate an encoded bitstream. The encoded bitstream may be provided via the output device 660 as an output 680.

In the example embodiments of performing point cloud decoding, the input device 650 may receive an encoded bitstream as the input 670. The encoded bitstream may be processed, for example, by the point cloud processing module 625, to generate decoded point cloud data. The decoded point cloud data may be provided via the output device 660 as the output 680.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for point cloud processing, comprising:
obtaining, for a conversion between a current point cloud (PC) sample of a point cloud sequence and a bitstream of the point cloud sequence, a first set of points of the current PC sample, the first set of points representing low frequency information of the current PC sample;
obtaining a first feature associated with high frequency information of the current PC sample; and
performing the conversion based on the first set of points and the first feature.

2. The method of claim 1, wherein the conversion comprises encoding the current PC sample into the bitstream, or
wherein the first set of points is obtained by downsampling the current PC sample.

3. The method of claim 1, wherein the first set of points is obtained based on at least one of the following:
geometric character of the current PC sample, or attribute character of the current PC sample.

4. The method of claim 3, wherein the geometric character comprises geometric structure or geometric normal.

5. The method of claim 1, wherein the first set of points corresponds to a backbone structure of the current PC sample, or
wherein the first set of points is obtained based on a farthest point sampling scheme, or
wherein the first set of points corresponds to a sparse point cloud obtained by applying a large granularity voxelization on the current PC sample, or
wherein the first set of points is obtained with a first machine learning based (ML-based) model.

6. The method of claim 5, wherein the first ML-based model comprises a neural network, and the neural network is implemented based on a sparse convolution.

7. The method of claim 1, wherein obtaining the first feature comprises:
obtaining a second set of points of the current PC sample, the second set of points representing the high frequency information of the current PC sample;
generating a high frequency feature based on the second set of points; and
generating the first feature based on the high frequency feature.

8. The method of claim 7, wherein the second set of points is obtained by downsampling the current PC sample, or
wherein the second set of points is obtained based on geometric character of the current PC sample, or
wherein the second set of points are determined as points of the current PC sample excluding the first set of points, or
wherein the high frequency feature is determined as a feature obtained by convolutional downsampling, or
wherein the high frequency feature is generated with a predetermined operator or a second ML-based model.

9. The method of claim 8, wherein the second ML-based model comprises a neural network, and the neural network is implemented based on a sparse convolution.

10. The method of claim 1, wherein the conversion includes decoding the current PC sample from the bitstream, or
wherein the first set of points is obtained from the bitstream, and/or the first feature is obtained from the bitstream.

11. The method of claim 1, wherein performing the conversion comprises:
generating a prediction for a high frequency feature based on the first feature; and
reconstructing the current PC sample by applying a upsampling process on the first set of points based on the prediction for the high frequency feature.

12. The method of claim 11, wherein the prediction for the high frequency feature is generated with at least one of the following: a convolution operation, a complex variable-point expansion operation, or a variable-point feature expansion operation, or
wherein the prediction for the high frequency feature is generated with a third ML-based model, and parameters of the third ML-based model are updated based on a loss function during a training process of the third ML-based model, or
wherein the upsampling process comprises a single upsampling operation, or
wherein the upsampling process comprises a plurality of upsampling operations that are performed iteratively, or
wherein the upsampling process is applied by using a sparse convolution-based generative convolution.

13. The method of claim 11, wherein parameters of a fourth ML-based model for applying the upsampling process are updated based on multi-stage loss functions with different granularities during a training process of the fourth ML-based model.

14. The method of claim 13, wherein a loss function for the first stage of the multi-stage loss functions is determined to be a binary cross-entropy value, or
wherein the number of points used for determining loss functions for different stages of the multi-stage loss functions are different, or
wherein the number of points used for determining a loss function for each stage of the multi-stage loss functions is indicated by at least one indication, or
wherein the multi-stage loss functions are 3-stage loss functions, a loss function for the first stage of multi-stage loss functions is determined based on M % points of a point cloud that is obtained by voxel sampling from a real point cloud for training the fourth ML-based model, a loss function for the second stage of multi-stage loss functions is determined based on N % points of the point cloud, and a loss function for the last stage of multi-stage loss functions is determined based on K % points of the point cloud.

15. The method of claim 1, wherein a fifth ML-based model for downsampling the current PC sample to obtain the first set of points and a sixth ML-based model for upsampling the first set of points to reconstruct the current PC sample are trained with different schemes, or
wherein a fifth ML-based model for downsampling the current PC sample to obtain the first set of points and a sixth ML-based model for upsampling the first set of points to reconstruct the current PC sample are trained simultaneously, or
wherein a fifth ML-based model for downsampling the current PC sample to obtain the first set of points and a sixth ML-based model for upsampling the first set of points to reconstruct the current PC sample are trained separately, or
wherein a fifth ML-based model for downsampling the current PC sample to obtain the first set of points and a sixth ML-based model for upsampling the first set of points to reconstruct the current PC sample are trained separately after being trained simultaneously.

16. The method of claim 1, wherein the first set of points is signaled from an encoder to a decoder, or
wherein the first set of points is coded by a point cloud codec, or
wherein the first feature is signaled from an encoder to a decoder, or
wherein the first feature is coded with one of the following: a fixed-length coding, a unary coding, or a truncated unary coding, or
wherein the first feature is coded in a predictive way.

17. The method of claim 1, wherein a PC sample is one of the following:
a frame,
a picture,
a slice,
a sub-frame,
a sub-picture,
a tile, or
a segment.

18. An apparatus for point cloud processing comprising a processor and a non-transitory memory with instructions thereon, wherein the instructions upon execution by the processor, cause the processor to perform acts comprising:
obtaining, for a conversion between a current point cloud (PC) sample of a point cloud sequence and a bitstream of the point cloud sequence, a first set of points of the current PC sample, the first set of points representing low frequency information of the current PC sample;
obtaining a first feature associated with high frequency information of the current PC sample; and
performing the conversion based on the first set of points and the first feature.

19. A non-transitory computer-readable storage medium storing instructions that cause a processor to perform acts comprising:
obtaining, for a conversion between a current point cloud (PC) sample of a point cloud sequence and a bitstream of the point cloud sequence, a first set of points of the current PC sample, the first set of points representing low frequency information of the current PC sample;
obtaining a first feature associated with high frequency information of the current PC sample; and
performing the conversion based on the first set of points and the first feature.

20. A non-transitory computer-readable recording medium storing a bitstream of a point cloud sequence which is generated by a method performed by an apparatus for point cloud processing, wherein the method comprises:
obtaining a first set of points of a current PC sample of the point cloud sequence, the first set of points representing low frequency information of the current PC sample;
obtaining a first feature associated with high frequency information of the current PC sample; and
generating the bitstream based on the first set of points and the first feature.
